(19) United States
(12) Patent Application Publication
(10) Pub. No.: US 2009/0037246 A1
(43) Pub. Date: Feb. 5, 2009

(54) Resource allocation system and method

(75) Inventors: Matthew R. Taylor, East Peoria, IL (US); Jeffery E. Garrett, Morton, IL (US); Randy M. Kelly, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/882,233

(22) Filed: Jul. 31, 2007

(51) Int. Cl. G06Q 10/00; G06F 3/14

(52) U.S. Cl. 705/8; 715/246

(57) ABSTRACT

A method for resource planning in a business organization may include receiving project data describing a project assigned to a group in the business organization. The project data may include a time period in which the project should be completed by the group, a resource availability value for the group during the time period, and a resource requirement value for the group during the time period. The method may also include a determining a resource disparity value indicative of disparity between the resource availability value and the resource requirement value for the group in the time period. The method may further include displaying the resource disparity value for the group in the time period.

### TECHNICAL FIELD

The present disclosure relates generally to a system and method for resource allocation and relates more particularly to a system and method for allocating resources in a business organization.

### BACKGROUND

A business organization may include a plurality of groups or departments. Each group may attempt to complete one or more projects or tasks for the business organization within specified periods of time. The business organization's managers may allocate resources to the groups, helping to ensure that the groups have the resources necessary to complete the projects in the time provided. Resources may include human resources, machinery or equipment, raw materials, physical space, or capital. If a group is not provided with the resources necessary to complete its projects in the time provided, the business organization may find itself unable to meet the timing and quality expectations of its customers. On the other hand, if a group has excess resources, the business organization may sustain losses in the form of costs associated with maintaining the excess resources while they sit unused. Thus, managers in the business organization may seek to allocate resources effectively to avoid delays, while also avoiding inefficiency.

At least one system has been developed to assist with the allocation of resources. For example, U.S. Pat. No. 6,985,872 to Benbassat et al. (“Benbassat”) discloses a system and method for assigning human resources to service tasks. The method disclosed in Benbassat includes providing data regarding historical needs and future demand for human resources, forecasting the requirements for human resources in the long-term, planning and updating the human resources according to the forecast, assigning human resources, accounting for changes, and continuously analyzing the effects of the previously described steps to detect problems. However, Benbassat does not provide a business organization's managers with an intuitive output that allows the managers to quickly identify areas with under or over-allocation of resources. Further, Benbassat relies heavily on historical statistical data to forecast resource needs, which may lead to inaccuracies if actual resource needs fall outside of ranges defined by the historical statistical data.

The system and method of the present disclosure is directed towards overcoming one or more of the constraints set forth above.

### SUMMARY OF THE INVENTION

In one aspect, the presently disclosed embodiments may be directed to a method for resource planning in a business organization. The method may include receiving project data describing a project assigned to a group in the business organization. The project data may include a time period in which the project should be completed by the group, a resource availability value for the group during the time period, and a resource requirement value for the group during the time period. The method may also include determining a resource disparity value indicative of disparity between the resource availability value and the resource requirement value for the group in the time period. The method may further include displaying the resource disparity value for the group in the time period.

In another aspect, the presently disclosed embodiments may be directed to a computer system including a platform, a display device, and a processor in communication with the platform and the display device. The processor may be configured to receive project data describing a project assigned to a group in the business organization. The project data may include a time period in which the project should be completed by the group, a resource availability value for the group during the time period, and a resource requirement value for the group during the time period. The processor may also be configured to determine a resource disparity value indicative of disparity between the resource availability value and the resource requirement value for the group in the time period. The processor may further be configured to display the resource disparity value for the group in the time period.

### BRIEF DESCRIPTION OF THE DRAWINGS

FIG. 1 is a schematic illustration of a resource allocation system, according to an exemplary embodiment of the present disclosure.

FIG. 2 is a flow diagram of a resource allocation method, according to an exemplary embodiment of the present disclosure.

FIG. 3 is an illustration of a summary window, according to an exemplary feature of the present disclosure.

FIG. 4 is an illustration of a summary window, according to another exemplary feature of the present disclosure.

### DETAILED DESCRIPTION

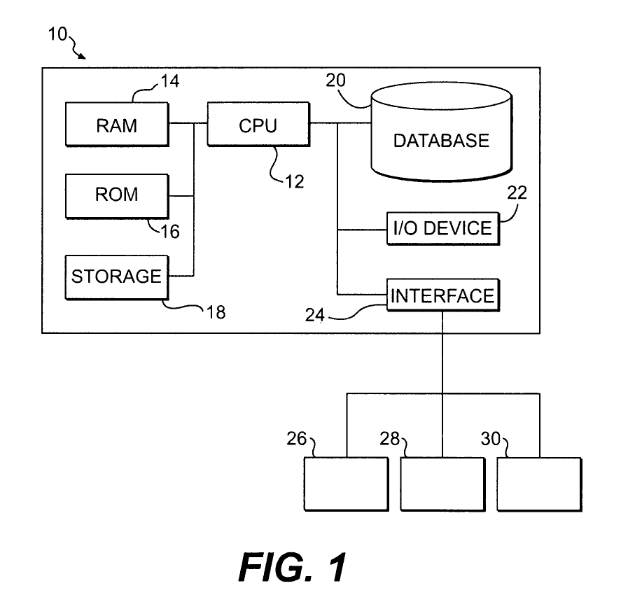

An exemplary embodiment of a resource allocation system 10 is shown in FIG. 1. Resource allocation system 10 may be used in virtually any business environment. Resources may include, for example, human resources, raw materials, machinery, equipment, space, capital, and/or any other resources a business organization may use in its operations. Resource allocation system 10 may receive, process, and convey information to assist managers in the business organization with the task of allocating resources.

Resource allocation system 10 may include any type of processor-based system on which processes and methods consistent with the disclosed embodiments may be implemented. Resource allocation system 10 may be a platform that includes one or more hardware and/or software components configured to execute software programs. Exemplary hardware components may include a central processing unit (“CPU”) 12, a random access memory (“RAM”) module 14, a read-only memory (“ROM”) module 16, a storage 18, a database 20, an input/output (“I/O”) device 22, and an interface 24. Exemplary software components may include a computer-readable medium with computer-executable instructions for performing methods consistent with certain disclosed embodiments. One or more of the hardware components listed above may implement the software, and in doing so, may perform one or more operations. It should be understood that resource allocation system 10 may include additional, fewer, and/or different components than those listed above, as the components listed above are exemplary and not intended to be limiting.

CPU 12 may include one or more processors, each configured to execute instructions and process data to perform one or more functions associated with resource allocation system 10. CPU 12 may be communicatively coupled to RAM 14, ROM 16, storage 18, database 20, I/O device 22, and interface 24. CPU 12 may execute sequences of computer program instructions to perform various processes, which will be described in detail below. The computer program instructions may be loaded into RAM 14 for execution by CPU 12.

RAM 14 and ROM 16 may each include one or more devices for storing information associated with operations of resource allocation system 10. RAM 14 may include a memory device for storing data associated with one or more operations of CPU 12. ROM 16 may include a memory device configured to access and store information associated with system 10, including information for creating and monitoring one or more tasks. ROM 16 may load instructions into RAM 14 for execution by CPU 12.

Storage 18 may include any type of mass storage device configured to store information that CPU 12 may need to perform processes consistent with the disclosed embodiments. For example, storage 18 may include one or more magnetic and/or optical disk devices, such as hard drives, CD-ROMs, DVD-ROMs, or any other type of mass media device.

Database 20 may include one or more software and/or hardware components that cooperate to store, organize, sort, filter, and/or arrange data used by resource allocation system 10. Database 20 may receive and store a listing of groups in the business organization, projects assigned to each of the groups, and project data for each of the projects. The project data may include, for example, a time period in which a project is scheduled to be completed, the resources that will be required for the project to be completed within the prescribed time period, and the resources that are available for use in completing the project during the time period. The types of information described herein are exemplary, and it should be understood that the information may include any suitable information a business may find useful in planning and executing its operations. CPU 12 may access the information stored in database 20, and may process, organize, and convey the information to users.

I/O device 22 may include one or more components configured to communicate information between a user and resource allocation system 10. For example, I/O device 22 may include a console with an integrated keyboard and mouse to allow a user to input parameters associated with resource allocation system 10. I/O device 22 may also include a display, such as a monitor, including a graphical user interface (“GUI”) for outputting information. I/O device 22 may also include peripheral devices such as, for example, a printer for printing information and reports associated with system 10, a user-accessible disk drive (e.g., a USB port, a floppy, CD-ROM, or DVD-ROM drive) to allow a user to input data stored on a portable media device, a microphone, a speaker system, or any other suitable type of interface device. Output from resource allocation system 10 may be sent to I/O device 22 for printed display, viewing, and/or further communication to other system devices.

Interface 24 may include one or more components configured to transmit and receive data via a communication network, such as the Internet, a local area network, a workstation peer-to-peer network, a direct link network, a wireless network, or any other suitable communication platform. In this manner, resource allocation system 10 may communicate with external systems through the use of a network architecture (not shown). In such an embodiment, the network architecture may include, alone or in any suitable combination, a telephone-based network (such as a PBX or POTS), a local area network (“LAN”), a wide area network (“WAN”), a dedicated intranet, and/or the Internet. Further, the network architecture may include any suitable combination of wired and/or wireless components and systems. For example, interface 24 may include one or more modulators, demodulators, multiplexers, demultiplexers, network communication devices, wireless devices, antennas, modems, and any other type of device configured to enable data communication via a communication network. Each group in a business organization may employ its own group computer systems 26, 28, and 30, that may be used to send information to and receive information from resource allocation system 10 through interface 24. It should be understood that a greater number or lesser number of group computer systems may be used, and that the number of group computer systems may correspond to the number of groups in the business organization.

Those skilled in the art will appreciate that all or part of systems and methods consistent with the present disclosure may be stored on or read from other computer-readable media. Resource allocation system 10 may execute instructions provided in a computer-readable medium having stored thereon machine executable instructions for performing, among other things, the methods disclosed herein. Exemplary computer readable media may include secondary storage devices, like hard disks, floppy disks, and CD-ROM; or other forms of computer-readable memory. Such computer-readable media may be embodied by one or more components, including, for example, such as CPU 12, storage 18, database 20, or combinations of these and other components.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (“ASIC”) that are custom designed for this purpose.

The described implementation may include a particular network configuration but embodiments of the present disclosure may be implemented in a variety of data communication network environments using software, hardware, or a combination of hardware and software to provide the processing functions.

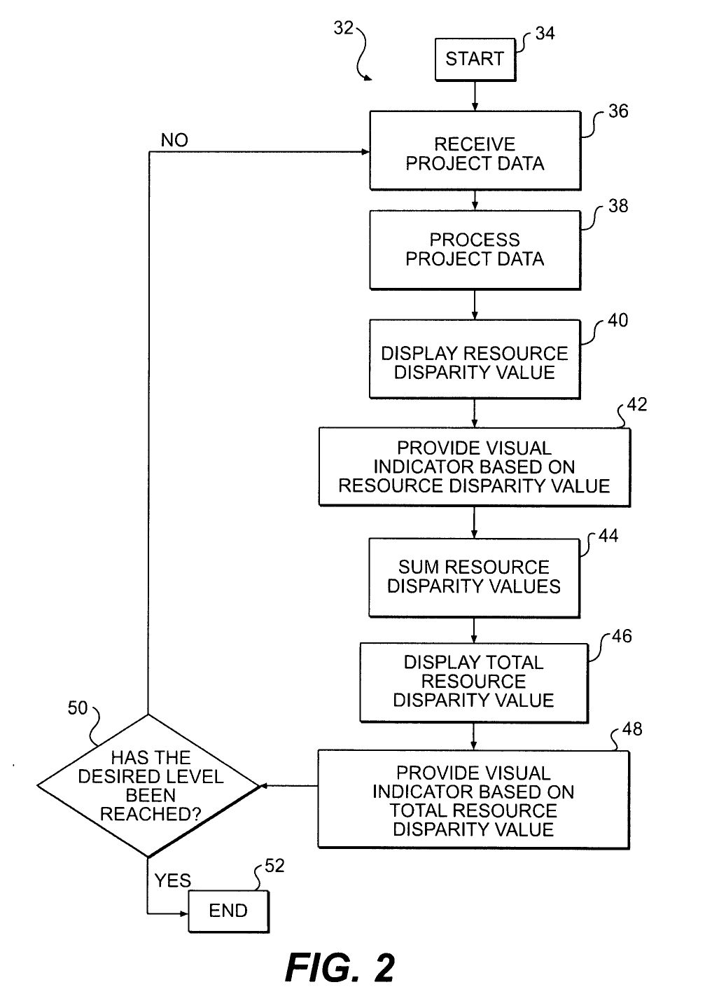

According to one aspect of this disclosure, resource allocation system 10 may be used to perform a method 32 described with reference to FIGS. 2-4. As shown in FIG. 2, method 32 may start (step 34) with resource allocation system 10 receiving project data (step 36). CPU 12 may receive project data from database 20 or from an external source. For example, managers or other entities in each group may import project data for their respective groups into resource allocation system 10 using group computer systems 26, 28, or 30. The project data may include any suitable data for describing projects assigned to groups in the business organization, such as, for example, time periods in which the projects should be completed by the groups, resource availability values for each group during each time period, and/or resource requirement values for each group during each time period.

Resource allocation system 10 may process the project data (step 38). Processing may include determining resource disparity values indicative of disparity between the resource availability values and the resource requirement values for each group in each time period. Processing may also include the act of filtering the project data. Filtering may include identifying project data that is of interest, and only processing that project data. Users may set and re-set filter criteria to define the type of filtering desired. For example, users may request that resource allocation system 10 only process project data related to certain groups in the business organization.

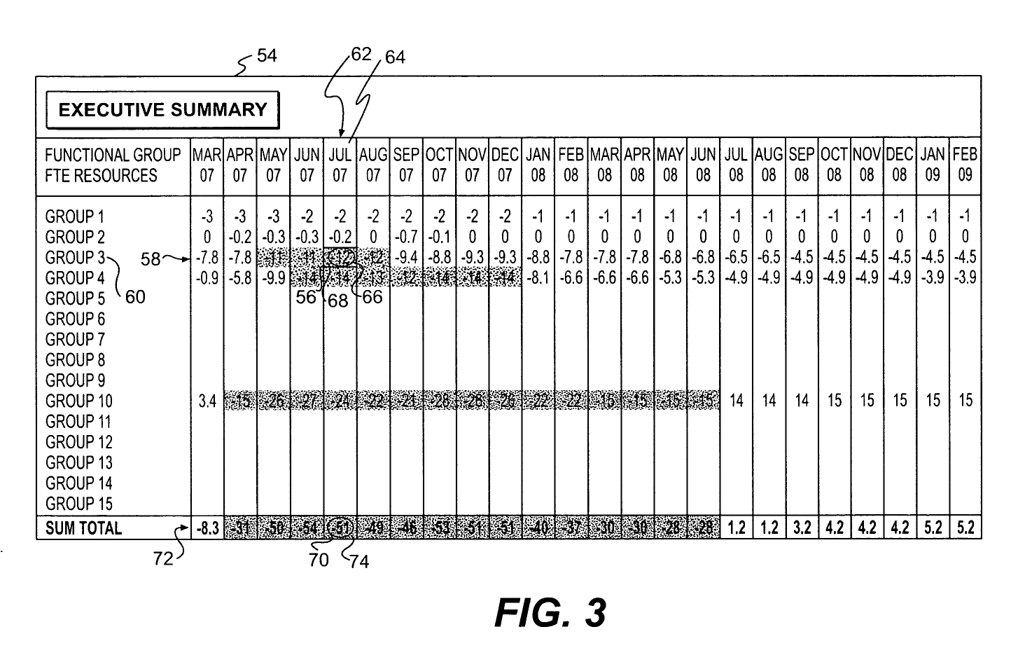

Resource allocation system 10 may then display resource disparity values for each group in each time period on a display, such as those described with regard to I/O device 22 (step 40). Displaying resource disparity values may include, for example, generating an executive summary 54 including a plurality of data cells, as shown in FIG. 3. An exemplary data cell 56 and an exemplary resource disparity value 66 are shown. The data cells may be organized in one or more rows with row headings. A row heading 60 for a row 58 may correspond to a group in the business organization, and the same may be said for the other row headings and other groups in the business organization. The data cells may also be organized in columns with column headings. A column heading 64 may correspond to a time period, and the time period may be expressed in terms of any suitable length of time, including, for example, seconds, hours, days, weeks, or years. The resource disparity value for a given group in a given time period may be displayed in the data cell corresponding to the given group and the given time period. Filtering may be performed by providing users with the ability to instruct resource allocation system 10 to filter the resource disparity values, so that executive summary 54 displays only those resource disparity values that users want to see. Filtering criteria may be entered in any suitable manner known in the art. For example, filtering criteria may be entered in an input screen (not shown) on group computer systems 26, 28, and 30.

The row headings shown are generic, but it should be understood that the row headings may describe groups by name and/or by functional description. For example, row headings for Groups 1-15 may include Account Managers, Solutions Center, Facility Engineering, Inventory Management, Human Resources, Program Management, Operations Process Engineering, Transportation, Manufacturing Logistics Engineering, Manufacturing Logistics and Transportation Systems, External Client Systems, Business Resources, Training Resources, Records Management, and Modeling. Different types of groups and row headings may be used for different business organizations.

Returning to the flow diagram of FIG. 2, the next step may include providing visual indicators in the data cells (step 42). An example of a visual indicator 68 in data cell 56 is shown in FIG. 3. The type of visual indicator used in a given data cell is selected based on the resource disparity value displayed in the data cell. Providing the visual indicators may include filling data cells with colors and/or patterns. Providing the visual indicators may also include bolding the outline of data cells, animating data cells or their contents, and/or using any other suitable methods for setting data cells and/or resource disparity values apart from other elements visually. The type, intensity, darkness, brightness, and/or shade of the visual indicators may be designed or selected to convey information to a user, such as, for example, the magnitude of a resource disparity value in a data cell. The resource disparity values may occupy positions along a color spectrum. Each data cell may be filled in with the color associated with its resource disparity value. It is contemplated that a threshold limit may be set, such that a visual indicator may not be assigned to a data cell unless the resource disparity value in the data cell exceeds the threshold limit.

As shown in FIG. 2, resource allocation system 10 may also sum the columns of resource disparity values to calculate total resource disparity values for each time period (step 44). The total resource disparity values, including total resource disparity value 70 in column 62, may be displayed in a total row 72 (step 46) comprised of the lowermost row of data cells in FIG. 3. Another step may include resource allocation system 10 providing visual indicators, such as visual indicator 74, in the data cells of total row 72 (step 48) in a manner similar to data cell 56.

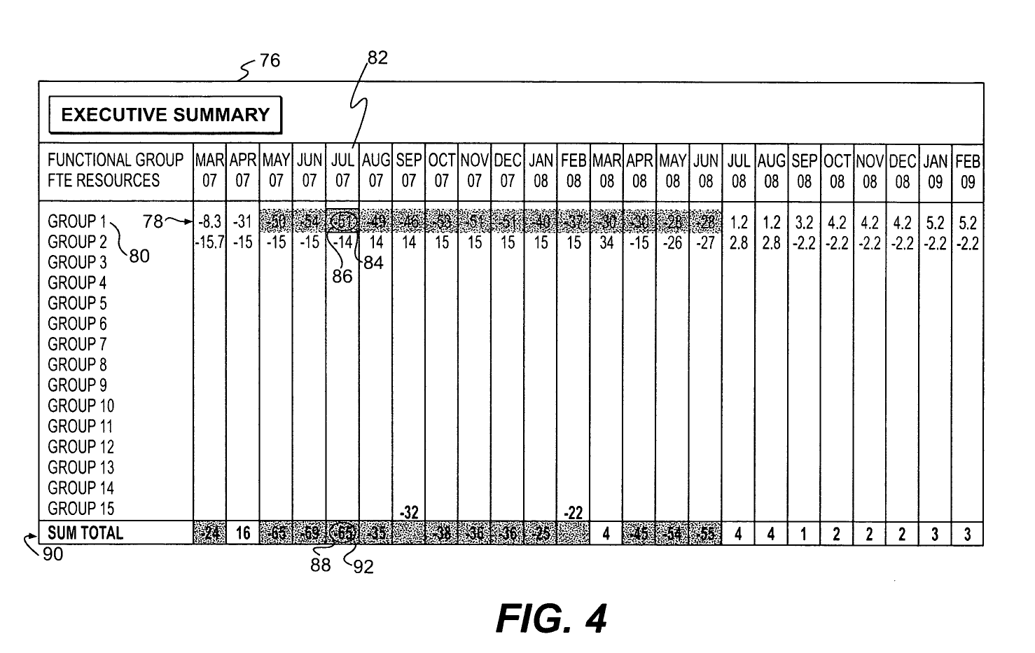

A business organization may be organized in a hierarchy. At the lower levels, the hierarchy may include a plurality of smaller groups. Each of those smaller groups may be part of a larger group in a higher level of the hierarchy. Each of the larger groups may in turn be part of an even larger group in an even higher level of the hierarchy. The hierarchical arrangement of entities in a business organization is known in the art. As applied to the present disclosure, the groups described thus far may be part of a larger group or division in the business organization. The resource disparity values in total row 72 may represent resource disparity values for each time period for the larger group or division. A user may determine whether the view of the business organization provided by executive summary is at a high enough level in the hierarchy of the business organization (step 50). For example, the user may determine whether executive summary 54 provides the information the user needs, or if it would be more helpful to analyze a higher level executive summary directed toward larger groups or divisions in the business organization. If a higher level executive summary is desired (NO), resource allocation system 10 may use the contents of total row 72 to help generate the higher level executive summary. An exemplary embodiment of a higher level executive summary 76 is shown in FIG. 4. The resource disparity values in total row 74 may be identical to those in row 78 of executive summary 76, since row 78 of executive summary 76 corresponds to the larger group or division made up of the groups listed in executive summary 54.

In executive summary 76, row headings, such as row heading 80, may correspond to larger groups or divisions in the business organization. Column headings, such as column heading 82, may correspond to time periods during which projects assigned to the larger groups or divisions should be completed. The resource disparity values in the data cells of executive summary 76 may be received from the total rows of lower level executive summaries. An exemplary resource disparity value 86, data cell 84, total resource disparity value 86, total row 90, and visual indicator 92 are shown. Steps similar to those used to generate executive summary 54 may be performed to generate executive summary 76. It should also be understood, that executive summary 76 may be used to complete part of an even higher level executive summary (not shown), in the way that executive summary 54 may be used to complete part of executive summary 76. Returning to FIG. 2, it is shown that if the desired level of executive summary has been reached (YES), the method may end (step 52).

Resource availability values, resource requirement values, and resource disparity values may be expressed in terms of the number of full time equivalents. A full time equivalent (“FTE”) is a way to measure a worker's productivity and/or involvement in a project. A full time worker, that is, a worker that works the maximum allowed hours in a year, may be equated with 1.0 FTE. A worker that works only half the maximum allowed hours in a year may be equated with 0.5 FTE. However, resource availability values, resource requirement values, and resource disparity values may also be expressed in any other suitable terms, including the number of machines, the weight of raw material, the square footage of space, or in monetary units.

### INDUSTRIAL APPLICABILITY

A resource allocation system 10 and method 32 may have applicability in virtually any type of business organization, and in particular, those in which different divisions, groups, or departments use the same or similar resources. Processes and methods consistent with the disclosed embodiments may provide a simple, easily understood graphical user interface for conveying project data, and in particular, resource disparity values in various sectors or levels of the business organization during various time periods. As a result, users may be provided with the ability to identify and analyze the capabilities of the business organization, and design solutions to resource allocation problems.

Users of resource allocation system 10 and method 32 may include managers in the business organization. Using the information provided by an executive summary 54 generated by resource allocation system 10, managers may determine whether to re-schedule projects, modify projects to change their resource needs, purchase or hire additional resources, sell or terminate unneeded resources, shift resources between different divisions, groups, or departments, and/or take any other suitable actions. By doing so, managers may avoid problems, such as understaffing, which could cause delays in project completion to the detriment of the business organization and its customers. Managers may also avoid other problems, such as overstaffing, which may increase storage costs, maintenance costs, and overall inefficiency.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A method for resource planning in a business organization, the method comprising:
receiving project data describing a project assigned to a group in the business organization, wherein the project data includes:
a time period in which the project should be completed by the group,
a resource availability value for the group during the time period, and
a resource requirement value for the group during the time period,
determining a resource disparity value indicative of disparity between the resource availability value and the resource requirement value for the group in the time period; and
displaying the resource disparity value for the group in the time period.

2. The method of claim 1, wherein displaying the resource disparity value includes generating a summary including at least one data cell.

3. The method of claim 2, wherein displaying the resource disparity value further includes displaying the resource disparity value in the at least one data cell.

4. The method of claim 2, wherein generating the summary includes placing the at least one data cell into a row of data cells with a row heading corresponding to the group.

5. The method of claim 4, wherein generating the summary includes placing the at least one data cell into a column of data cells with a column heading corresponding to the time period.

6. The method of claim 5, further including summing resource disparity values in the column of data cells to calculate a total resource disparity value for the time period.

7. The method of claim 6, further including displaying the total resource disparity value in a total row of data cells in the executive summary.

8. The method of claim 7, further including generating another executive summary including at least one additional data cell.

9. The method of claim 8, wherein generating another executive summary includes placing the at least one additional data cell in a row of additional data cells with a row heading corresponding to a larger group in the business organization, wherein the group is part of the larger group.

10. The method of claim 9, wherein generating another executive summary further includes placing the at least one additional data cell in a column of data cells with the column heading.

11. The method of claim 9, wherein generating another executive summary further includes inserting values from the total row of data cells into the row of additional data cells.

12. The method of claim 2, wherein displaying the resource disparity value further includes providing a visual indicator in the at least one data cell.

13. The method of claim 12, wherein providing the visual indicator in the at least one data cell includes selecting the visual indicator based on the resource disparity value displayed in the at least one data cell.

14. The method of claim 13, wherein providing the visual indicator in the at least one data cell further includes providing the visual indicator when the resource disparity value falls outside a predetermined range.

15. The method of claim 1, further including filtering so that the received project data is processed only if the received project data meets pre-selected filtering criteria.

16. The method of claim 1, further including filtering so that the resource disparity value is displayed only if the resource disparity value meets pre-selected filtering criteria.

17. The method of claim 1, wherein receiving project data includes receiving the resource availability value, the resource requirement value, and the resource disparity value, expressed in terms of a number of full-time equivalents.

18. The method of claim 1, wherein receiving project data includes receiving the resource availability value, the resource requirement value, and the resource disparity value, expressed in terms of a number of machines.

19. The method of claim 1, wherein receiving project data includes receiving the resource availability value, the resource requirement value, and the resource disparity value, expressed in terms of monetary units.

20. A computer system comprising:
a platform;
a display device; and
a processor in communication with the platform and the display device, wherein the processor is configured to:
receive project data describing a project assigned to a group in a business organization, wherein the project data includes:
a time period in which the project should be completed by the group,
a resource availability value for the group during the time period, and
a resource requirement value for the group during the time period,
determine a resource disparity value indicative of disparity between the resource availability value and the resource requirement value for the group in the time period; and
display the resource disparity value for the group in the time period.
